(19) United States
(12) Patent Application Publication
(10) Pub. No.: US 2024/0096571 A1
(43) Pub. Date: Mar. 21, 2024

(54) TAP IN SMART SWITCH

(71) Applicant: Hall Labs LLC, Provo, UT (US)

(72) Inventors: David R. Hall, Provo, UT (US); Jerome Miles, Spanish Fork, UT (US); Seth Myer, Eagle Mountain, UT (US)

(73) Assignee: Hall Labs LLC, Provo, UT (US)

(21) Appl. No.: 17/932,381

(22) Filed: Sep. 15, 2022

(51) Int. Cl. H01H 21/30; H01H 21/12; H01H 21/36

(52) U.S. Cl. CPC H01H 21/30; H01H 21/12; H01H 21/36

(57) ABSTRACT

The invention is a retrofit device for converting a standard switch to a smart switch. The retrofit device taps into an existing switch electrical terminal via one or more sliding arms with electrical contacts. The electrical contacts interface with the terminals, thus providing a control circuit to intervene or interrupt the existing switch function and allow a control system to control the electrical circuit the existing switch serves.

### TECHNICAL FIELD

This invention relates to smart switches.

### BACKGROUND

Many homes are now being equipped with “smart home” systems that include lighting control. Rather than traditional hand operated light switches, they have intelligent “smart” controls that allow the homeowner to have more control flexibility in their lighting. Smart switches also allow a home automation system to control the lighting. In some cases, the smart switch may also allow remote control of the lighting when a homeowner is not at home. For example, the lighting may be controlled via a network or cloud-based system that is connected to the lighting via smart switches in the home. Smart switches may be located on a wall in the room that it serves similar to traditional switches, but have additional features such as scene setting, motion sensing, and dimming yet still be controllable by the homeowner at the room location.

In some cases, it is desirable to convert traditional switches to smart switches. In this case, a device or structure is needed to connect the existing switch wiring to the home automation system or smart controller. There are retrofittable smart switches available to the homeowner that can replace the existing “dumb” switches. However, this requires the existing dumb switch to be removed and replaced with a new smart switch. Many homeowners may not have the skills or knowledge needed to remove the old switch and replace it. Even hiring an electrician to do this work requires considerable effort to unscrew the terminals on the switch, remove the existing wiring from the old switch, remove the screws attaching the switch device from the electrical box and replacing it with the new smart switch.

Other methods of tying into an existing switch may include spring loaded devices that are integral with a faceplate that make electrical connections to the old switch with prestressed or spring-loaded arms that hold an electrical contact against the terminals on the old switch. Disadvantages of this approach include a limited amount of pressure or force that can be applied to the terminal from the prestressed arm. Over time, the pressure or spring force may lessen and relax, thus weakening the electrical connection between the electrical contact and the terminal screw. This system is also difficult to align properly since the spring arms are integral to the faceplate and cannot be seen while it is being placed on to the existing switch.

### SUMMARY

In one aspect, the invention is a retrofit device for converting a standard switch to a smart switch. The retrofit device taps into an existing switch electrical terminal via one or more sliding arms with electrical contacts. The electrical contacts interface with the terminals, thus providing a control circuit to intervene or interrupt the existing switch function and allow a control system to take over control of the electrical circuit the existing switch serves.

In a preferred embodiment, the retrofit device for connecting to a switch in an electrical box comprises a retrofit device for converting a standard switch to a smart switch. The retrofit device taps into an existing switch electrical terminal via one or more sliding arms with electrical contacts. The electrical contacts interface with the terminals, thus providing a control circuit to intervene or interrupt the existing switch function and allow a control system to control the electrical circuit the existing switch serves.

This invention has been developed in response to the present state of the art and, in particular, in response to the problems and needs in the art that have not yet been fully solved by currently available systems and methods. Features and advantages of different embodiments of the invention will become more fully apparent from the following description and appended claims or may be learned by practice of the invention as set forth hereinafter.

Consistent with the foregoing, a retrofit device for converting a standard switch to a smart switch is disclosed. The objectives of the system are to provide a retrofit device for converting a standard switch to a smart switch. The retrofit device taps into an existing switch electrical terminal via one or more sliding arms with electrical contacts. The electrical contacts interface with the terminals, thus providing a control circuit to intervene or interrupt the existing switch function and allow a control system to control the electrical circuit the existing switch serves.

In a preferred embodiment, a retrofit device for converting a standard switch to a smart switch may include a retrofit device for connecting to a switch with screw terminals in an electrical box. The device may include a sliding arm with a collar and a locking mechanism. The device may also include a flat bar, and the sliding arm collar may slide along the flat bar. The sliding arm may also include an electrical contact at an extended end of the arm that is configured to interface with a screw terminal. The sliding arm may then slide along the flat bar until the electrical contact interfaces with the screw terminal. The locking mechanism may lock the sliding arm to the flat bar, thus maintaining pressure between the electrical contact and the screw terminal. The locking mechanism may also include a ratcheting device to increase the pressure between the electrical contact and the screw terminal with each step that it is further ratcheted.

In another embodiment, the retrofit device may be attached to the electrical box with screws. In an embodiment, the retrofit device may be attached to the electrical box with the same screws that attach a faceplate to the electrical box. In a certain embodiment, the retrofit device may include a snap-in connector mating with a snap-in faceplate connector. The device may have a screw-less faceplate that is designed to snap-in to the device via friction fit connectors.

In certain embodiments, the locking mechanism may also include a release mechanism for releasing the collar from the flat bar. In an embodiment, the length of the electrical contact is at least double the width of the diameter of the screw terminal. This may allow the contact to be slightly misaligned with the terminal screw and still make contact when it is slid into place and pressure is applied to the connection.

In an embodiment, the retrofit device may also include an electrical circuit. The electrical circuit may be an AC circuit controlled by the switch. The retrofit device may also include an electronic circuit mounted to a circuit board. The electronic circuit may include a processor and non-transitory memory and an energy storage device like a battery or capacitor. The electronic circuit may also include a wireless connection to a local or cloud-based network for control. The retrofit device may also include an electrical controller and an electrical load. In an embodiment, the electrical controller may interrupt the electrical circuit at the switch and control the AC circuit.

In other embodiments, the ratcheting device may include a linear rack with teeth and spring-loaded pawl interface. The ratcheting device may include cams, gears, screws, leaf springs, and other standard known mechanical devices to achieve the ratcheting function. The purpose of the mechanical ratcheting device is to force the arm with electrical contact against the existing switch screw terminal, and hold it tight with enough force that it will not relax appreciably over time, thus maintaining an effective electrical interface connection between the electrical contact and the screw terminal.

In an embodiment, the sliding arm may also include multiple electrical contacts. The multiple electrical contacts may be arranged on the arm to align with a range of screw terminal locations. Each of the multiple electrical contacts may have a separate electrical conductor home run to the electronic circuit. The multiple electrical contacts may be mounted to a flexible foam backing, thus causing the electrical contacts to conform to the screw terminals when the ratcheting device increases the pressure between the electrical contact and the screw terminal. The multiple electrical contacts may be mounted to a spring-loaded backing.

In another embodiment, the electrical contact may also include an electrically conductive paste coating to enhance the electrical connection between the electrical contact and the screw terminal. A terminal screw facing section of the electrical contact may be spike shaped, enhancing penetration connection of the electrical interface between the electrical contact and the screw terminal.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is an isometric view of a switch with retrofit devices on the top and bottom of the switch.

FIG. 2 is an isometric view of two sliding arms with collars on a flat bar.

FIG. 3A is a top view of two sliding arms with collars on a flat bar.

FIG. 3B is a side view of two sliding arms with collars on a flat bar with ratcheting device and release mechanism.

FIG. 4 is a perspective view of an electrical box with retrofit devices and two switches.

FIG. 5A is a top view of a double decora switch with retrofit device.

FIG. 5B is a top view of a standard switch with retrofit device.

FIG. 6 is a top view of a double decora switch and retrofit device with multiple electrical contacts.

FIG. 7A is a top view of a double decora switch and retrofit device showing multiple electrical contacts with foam backing.

FIG. 7B is a close-up view of a terminal screw in contact with multiple electrical contacts.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

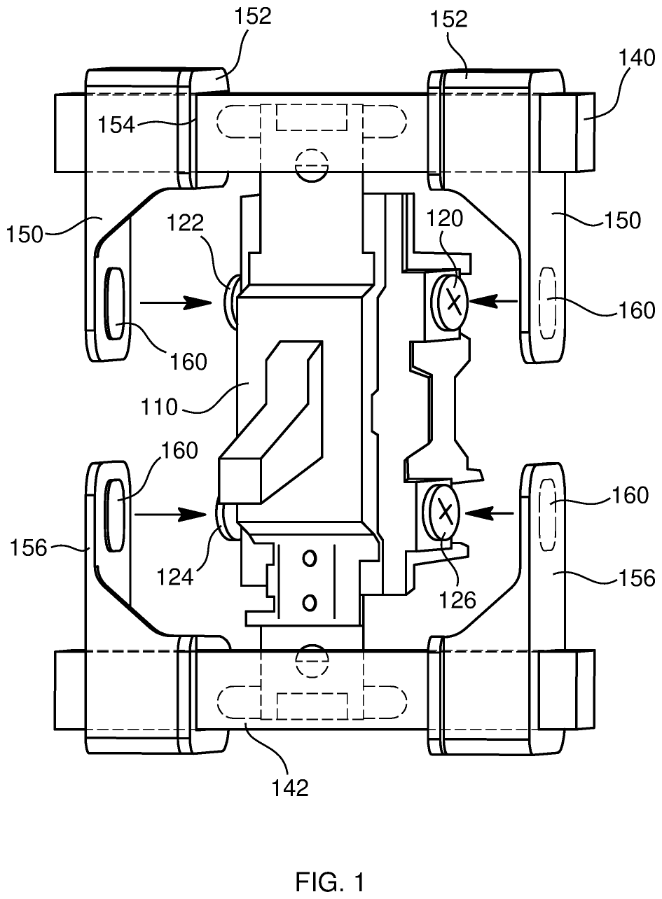

FIG. 1 is an isometric view of a switch with retrofit devices on the top and bottom of the switch. Existing electrical switch 110 is shown with flat bar 140 at the top of the switch with sliding arms 150 on either side of the screw terminals 120 and 122. Electrical contacts 160 align with terminal screws 120 and 122 as shown. Collars 152 retain sliding arms 150 on the flat bar 140, guiding them along the flat bar track so that the two sliding arms 150 may be pushed in towards the terminal screws 120 and 122. Locking mechanism 154 locks sliding arms 150 in place once they have been slid into position. The sliding arm 150 is then slid tight against the terminal screw 122, and the locking mechanism 154 retains the sliding arm 150 firmly in place, holding electrical contact 160 tight to the screw terminal 122. Lower flat bar 142 is also shown with sliding arms 156 aligning electrical contacts 160 with lower screw terminals 124 and 126.

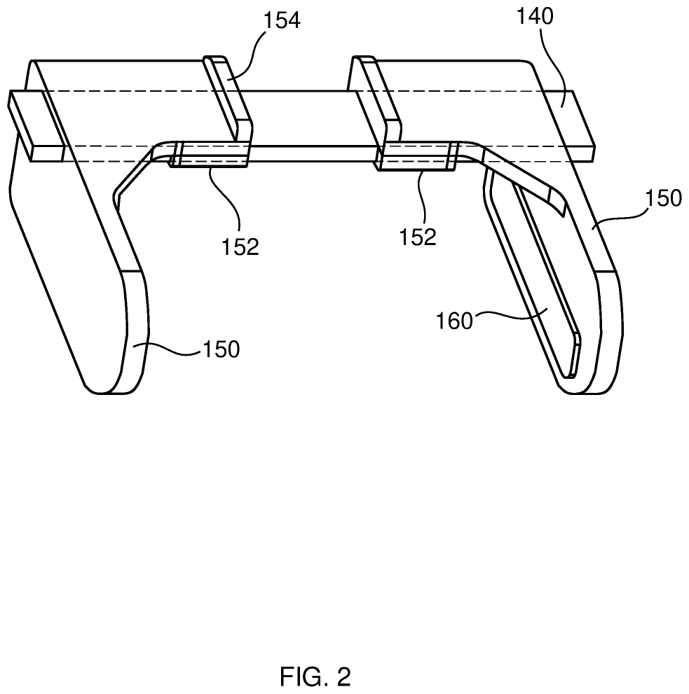

FIG. 2 is an isometric view of two sliding arms with collars on a flat bar. Flat bar 140 is shown with two sliding arms 150 and retaining collars 152. Locking mechanism 154 and electrical contact 160 are also shown. Collars 152 retain the sliding arms on the flat bar providing structure and stability as the sliding arms 150 are slid inward. In this example embodiment, the length of the electrical contact 160 is longer than double the width of a screw terminal. This allows ample length of “play” or misalignment of the electrical contact to still align with and make an electrical connection to the screw terminal.

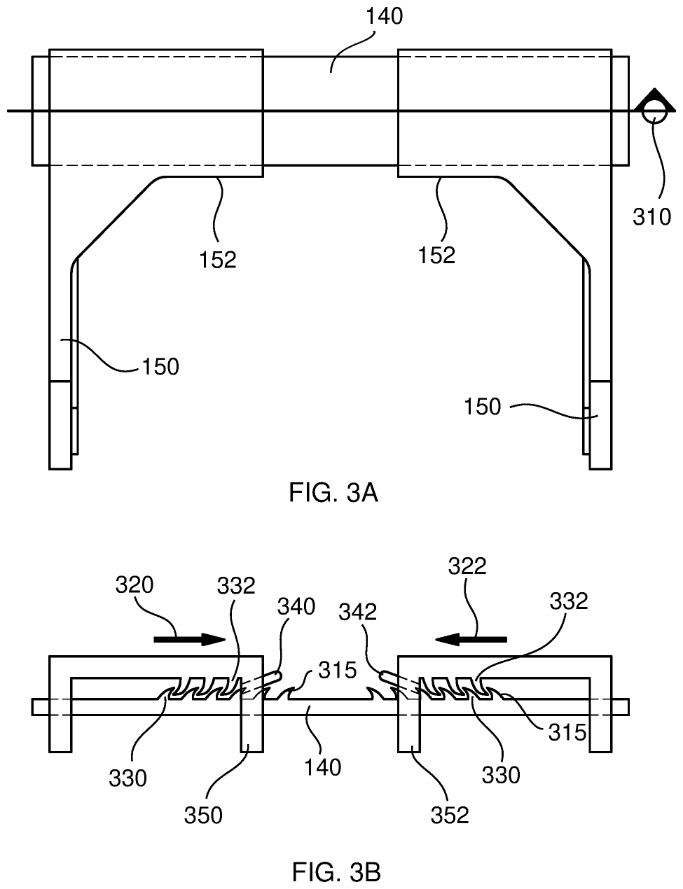

FIG. 3A is a top view of two sliding arms with collars on a flat bar. Sliding arms 150 are shown held in position by collars 152, tracking along the flat bar 140. Section 301 is shown in FIG. 3B.

FIG. 3B is a side view of two sliding arms with collars on a flat bar with ratcheting device and release mechanism. In this example embodiment, Flat bar 140 is equipped with linear racks 315, further comprising ratcheting device teeth 330 which interface with spring-loaded pawls 332 as shown. Collar 350 moves in direction 320 freely until it is in the desired position, with pawls 332 holding collar 350 in place. Collar 350 may be mechanically released if needed by pushing release mechanism 340 to release the collar and allow it to be moved in the opposite direction. Likewise, collar 352 moves in direction 322 freely until it is in the desired position, with pawls 332 holding collar 352 in place. Collar 352 may also be mechanically released if needed by pushing release mechanism 340 to release the collar 352 and allowing it to be slid back away from the locked position.

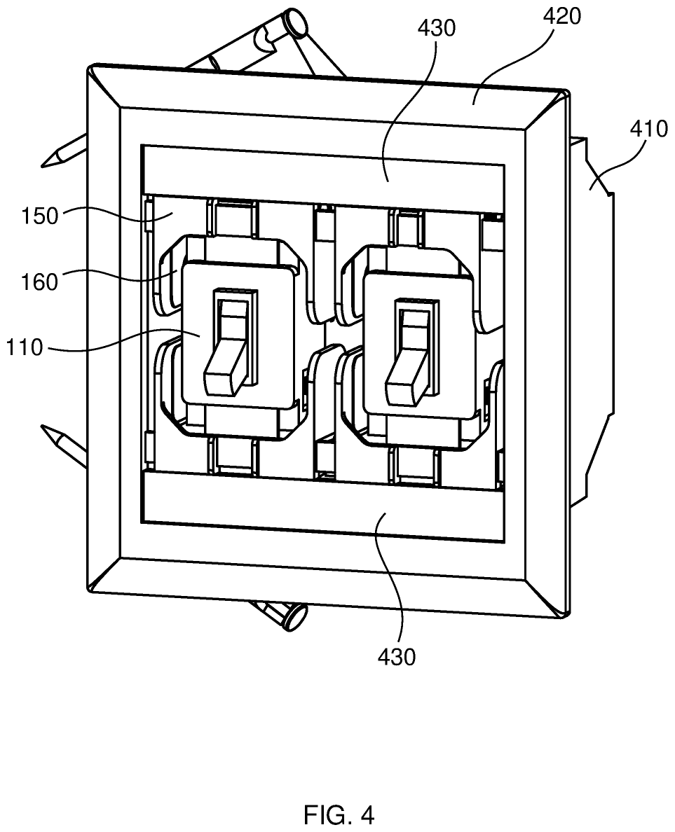

FIG. 4 is a perspective view of an electrical box with retrofit devices and two switches. Existing switch 110 is shown inside existing electrical box 410. Faceplate 420 may be snapped into the retrofit device as shown with snap-in friction connections to members 430 as shown. Sliding arm 150 and electrical contact 160 is also shown. As illustrated in this example embodiment, there may be four sliding arms for each switch, with each sliding arm and associated electrical contact serving a screw terminal on the side of each switch. In some cases, there may be four or more terminal screws on the sides of the switches being served.

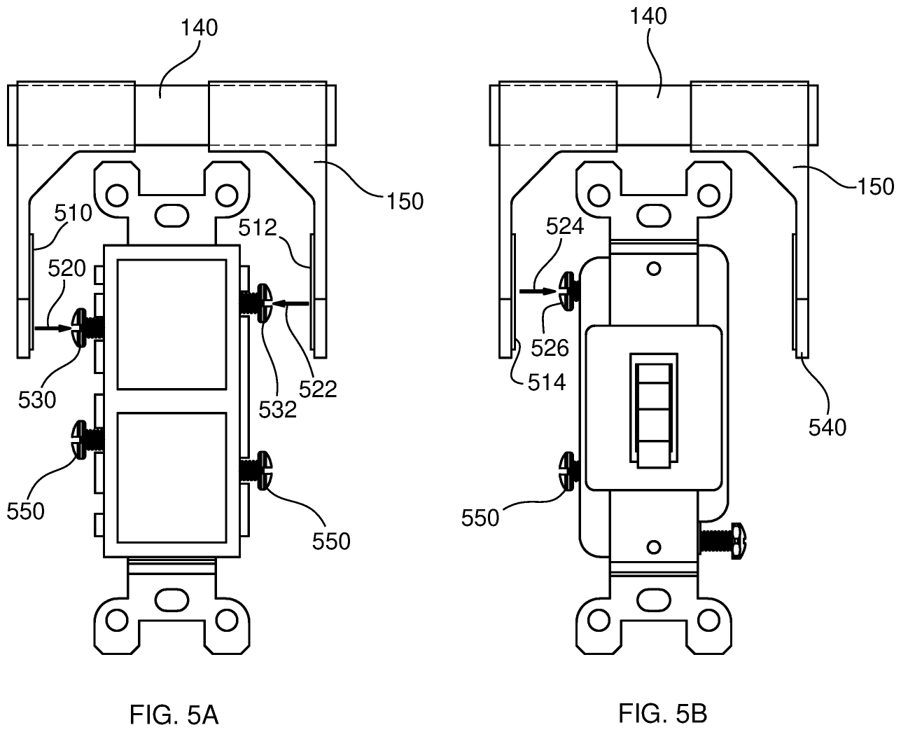

FIG. 5A is a top view of a double decora switch with retrofit device. Flat bar 140 is shown with sliding arms 150. In this example embodiment, electrical contact 510 is long enough to assure that the electrical contact will align with screw terminal 530 as shown by arrow 520. In a like manner, electrical contact 512 is long enough to assure that the electrical contact will align with screw terminal 532 as shown by arrow 522. Lower screw terminals 550 are shown for reference in different positional locations with respect to the needed alignment of electrical contacts.

FIG. 5B is a top view of a standard switch with retrofit device. Flat bar 140 is shown with sliding arms 150. In this example embodiment, electrical contact 514 aligns 524 with screw terminal 526 as shown. Position 540 of sliding arm 150 is retained since there are no screw terminals on the right side of the switch as shown. Lower screw terminal 550 is shown.

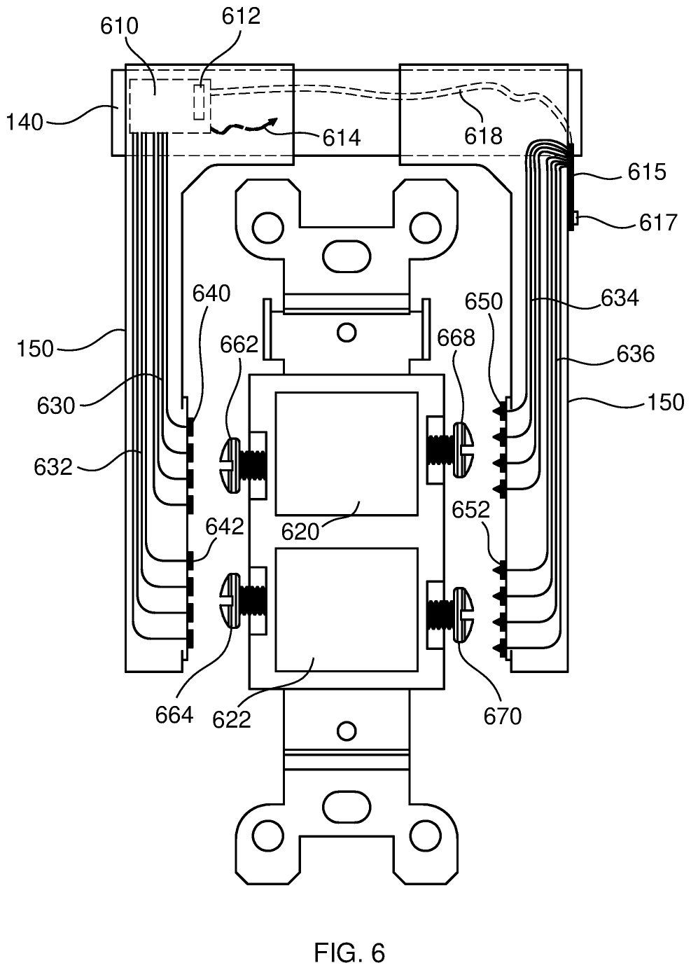

FIG. 6 is a top view of a double decora switch and retrofit device with multiple electrical contacts. Flat bar 140 is shown with sliding arms 150. Multiple electrical contacts 640, 642, 650 and 652 are shown. Electrical contacts 640 align with screw terminal 662 of switch 620. Multiple electrical conductors 630 connect each of the individual electrical contacts 640 to the electronic circuit 610 mounted to a circuit board. Controller 612 recognizes which of the electrical contacts 640 are making electrical contact and have good continuity by testing each of these connections. Those of the contacts that report good connections are then used by a control system to interface with the AC circuit served by the system. These multiple available connection points allow the set of contacts to serve one or more terminals if needed. It also allows isolation of any connections that may be associated with a separate electrical connection point. Controller 612 may provide a control interface, allowing a home automation system or wireless to control the AC circuit served by the existing switch 620. In some embodiments electronic circuit 615 with circuit board and controller 617 may be mounted on sliding arm 150. Control wiring 618 may connect multiple electronic circuits. Wiring 614 may connect to a control system.

Electrical contacts 650 are spiked shaped and align with screw terminal 668 of switch 620. Multiple electrical conductors 634 connect each of the individual electrical contacts 650 to the electronic circuit 615 mounted to a circuit board.

Electrical contacts 642 align with screw terminal 664 of switch 622. Multiple electrical conductors 632 connect each of the individual electrical contacts 642 to the electronic circuit 610 mounted to a circuit board.

Electrical contacts 652 are spike shaped and align with screw terminal 670 of switch 622. Multiple electrical conductors 636 connect each of the individual electrical contacts 652 to the electronic circuit 615 mounted to a circuit board.

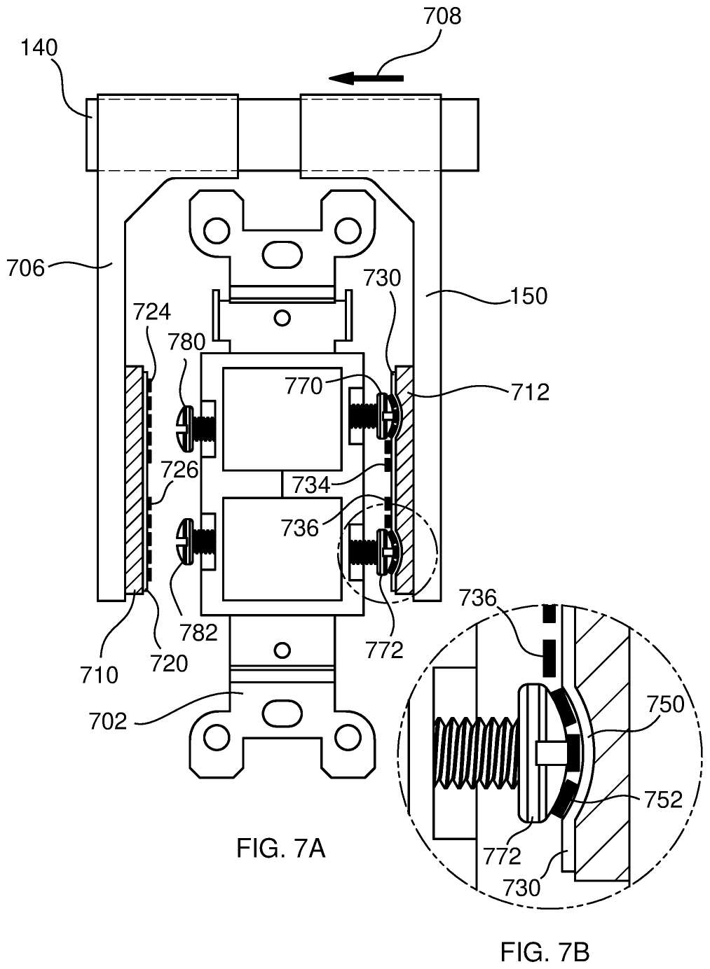

FIG. 7A is a top view of a double decora switch and retrofit device showing multiple electrical contacts with foam backing. Flat Bar 140 is shown with sliding arm 150 and sliding arm 706. In this example embodiment, sliding arm 706 is shown in a position on the right side of double decora switch 702. Contacts 724 align with screw terminal 780, and contacts 726 align with screw terminal 782. The electrical contacts 724 and 726 are mounted to flexible structure 720 on a surface of foam backing 710. Sliding arm 150 is shown after having been slid 708 tight against screw terminals 770 and 772. Electrical contacts 734 and 736 are shown in a fully compressed state, conforming to the shape of the terminal screws as shown. Flexible material 750 has been deformed to allow for this conforming, and foam backing 712 has been compressed to allow sliding arm 150 to be ratcheted tightly in place. The pressure of the ratcheting mechanism maintains this arm in this position with the foam in a compressed state.

FIG. 7B is a close-up view of a terminal screw in contact with multiple electrical contacts. Electrical contacts 736 are shown, and contacts 752 have been compressed and deformed to conform to terminal screw 772 as shown. Flexible material 730 has been deformed 750 as required to allow for this conformation.

The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A retrofit device for connecting to a switch in an electrical box, the switch comprising screw terminals, the device comprising:
at least one sliding arm with a collar and a locking mechanism;
a flat bar, wherein the sliding arm collar slides along the flat bar;
wherein the sliding arm further comprising an electrical contact configured to interface with a screw terminal;
wherein the sliding arm is slid along the flat bar until the electrical contact interfaces with the screw terminal;
wherein the locking mechanism locks the sliding arm to the flat bar, thus maintaining pressure between the electrical contact and the screw terminal; and
wherein the locking mechanism further comprising a ratcheting device to increase the pressure between the electrical contact and the screw terminal with each step that it is further ratcheted.

2. The invention of claim 1, wherein the retrofit device is attached to the electrical box with screws.

3. The invention of claim 1, wherein the retrofit device is attached to the electrical box with the same screws that attach a faceplate to the electrical box.

4. The invention of claim 1, wherein the retrofit device further comprising a snap-in connector mating with a snap-in faceplate connector.

5. The invention of claim 1, wherein the locking mechanism further comprises a release mechanism for releasing the collar from the flat bar.

6. The invention of claim 1, wherein the length of the electrical contact is at least double the width of the diameter of the screw terminal.

7. The invention of claim 1, wherein the retrofit device further comprising an electrical circuit.

8. The invention of claim 7, wherein the electrical circuit is an AC circuit controlled by the switch.

9. The invention of claim 8, wherein the retrofit device further comprises an electronic circuit mounted to a circuit board.

10. The invention of claim 9, wherein the retrofit device further comprises an electrical controller.

11. The invention of claim 10, wherein the retrofit device further comprises an electrical load.

12. The invention of claim 10, wherein the electrical controller interrupts the electrical circuit at the switch and controls the AC circuit.

13. The invention of claim 1, wherein the ratcheting device comprising a linear rack with teeth and spring-loaded pawl interface.

14. The invention of claim 1, wherein the sliding arm further comprising multiple electrical contacts.

15. The invention of claim 14, wherein the multiple electrical contacts are arranged on the arm to align with a range of screw terminal locations.

16. The invention of claim 14, wherein each of the multiple electrical contacts have a separate electrical conductor home run to the electronic circuit.

17. The invention of claim 14, wherein the multiple electrical contacts are mounted to a flexible foam backing, thus causing the electrical contacts to conform to the screw terminals when the ratcheting device increases the pressure between the electrical contact and the screw terminal.

18. The invention of claim 14, wherein the multiple electrical contacts are mounted to a spring-loaded backing.

19. The invention of claim 1, wherein the electrical contact further comprising an electrically conductive paste coating to enhance the electrical connection between the electrical contact and the screw terminal.

20. The invention of claim 1, wherein a terminal screw facing section of the electrical contact is spike shaped, enhancing penetration connection of the electrical interface between the electrical contact and the screw terminal.
